(19) United States
(12) Patent Application Publication
(10) Pub. No.: US 2002/0148800 A1
(43) Pub. Date: Oct. 17, 2002

(54) Heat resistant neck part of synthetic resin bottle body

(76) Inventors: Tomoyuki Ozawa, Tokyo (JP); Hiroshi Sugiura, Tokyo (JP)

Correspondence Address: Oliff & Berridge, PO Box 19928, Alexandria, VA, 22320, US

(21) Appl. No.: 10/110,169

(22) PCT Filed: Jun. 12, 2001
(86) PCT No.: PCT/JP01/04937

(30) Foreign Application Priority Data
Aug. 11, 2000 (JP) 2000-244872

(51) Int. Cl. B32B 1/08

(52) U.S. Cl. 215/40; 428/36.9

(57) ABSTRACT

This invention comprises the heat- and pressure-resistant PCO neck obtained by utilizing the PCO (plastic closure only) neck structure and giving the heat resisting property to the PCO neck to obtain the heat-resistant PCO neck that will make a great deal of resources saving a reality. The heat-resistant PCO bottleneck comprises the round neck wall 2 having the same outer and bore diameters as the corresponding neck wall 21 of the heat-resistant neck 20; the thread ridge 3 of a continuous thread structure; the thread ridge extension disposed so as to keep a fixed distance from the top edge of the mouth and extending over the distance that corresponds to a wide central angle; and a bead ring 5 and a neck ring 7 molded in the same shapes as those of the PCO bottleneck 10. The bottleneck thus obtained causes no irregular shrinkage deformation and demonstrates high heat-resisting property and a sufficient resources-saving effect when the entire bottleneck is thermally crystallized and whitened.

### TECHNICAL FIELD

This invention relates to the structure of a heat-resistant neck of a synthetic resin bottle, which has been stretch blow molded from such a synthetic resin as the polyethylene terephthalate resin, and particularly to the heat-resistant bottleneck to be exclusively used also under pressure together with the plastic Pilfer proof cap.

### BACKGROUND OF THE INVENTION

As the bottleneck exclusively used jointly with the plastic Pilfer proof cap, the neck 10 with the PCO (plastic closure only) finish, such as shown in FIGS. 6 or 8, is known and used for carbonate beverage bottles made of synthetic resins, including especially those biaxially stretched and blow molded bottles of polyethylene terephthalate.

The PCO neck 10 is provided with intermittent thread ridges 12 disposed on the circumference of the round neck wall 11. Below the intermittent thread ridges 12 are the bead ring 14 and the neck ring 15, both of which are also disposed around the neck 10. The minor diameter of external thread, r3, of the intermittent thread ridges 12 is set shorter than the outer diameter of the bottle mouth. The start ridge 13 of the intermittent thread ridges 12 extends over the distance corresponding to a central angle of about 90 degrees. On the other hand, the upper side of this start ridge 13 has a flank angle of about 0 degree, as shown in FIG. 8.

The PCO neck 10 has the structure of intermittent thread ridges 12 because, when the bottle is opened, the pressure inside the bottle caused by a gas, such as carbon dioxide, finds better escape so that the cap 10 is prevented from being blown away. The start ridge 13 is provided also because it may be engaged with the thread ridges of the cap 30 so as to prevent the cap 30 from being blown away.

The PCO neck 10 is suitable for use with only the plastic Pilfer proof cap, with no need of using aluminum Pilfer proof cap that requires a far higher fitting force and a handling force than required for the plastic one. It becomes unnecessary, therefore, to give a large mechanical strength to both of the bead ring 14 and the neck ring 15. Naturally, these rings can be downsized. For the same reason, the neck wall 11 can be thinned, thus making it possible for the minor diameter of the external thread to be smaller than the outer diameter of the bottle mouth. Furthermore, the intermittent thread ridges 12 contribute to reduce the total amount of resins used for the PCO neck 10 to a larger extent than when other necks are used to fit the Pilfer proof caps.

Because in this PCO neck 10, the upper side of the start ridge 13 has a flank angle of about 0 degree, the start ridge 13 can be molded at a full height over its entire length. At the time when the bottle is opened for the first time, it can be made sure that the start ridge 13 is easily engaged with the thread ridge of the cap 30.

Even if the flank angle is set at about 0 degree for the upper side of the start ridge 13, there is no fear that the sealing lip 31 inside the cap may bump against the upper side of the start ridge 13 and makes fitting of the cap 30 out of order. This is because the cap 30 to be fitted is for the pressure use, and because the sealing lip 31, which defines the position of the lower, outside portion of the lining 32, is disposed at a high position inside the cap. This lower, outside portion of the lining or packing 32 is allowed to have only a small sealing function so that the inner pressure makes a fast escape when the bottle is opened for the first time.

As the bottleneck for use with the Pilfer proof caps, including aluminum caps, there is known the heat resistant neck 20, which has entirely been thermally crystallized, as shown in FIGS. 9 and 10.

This heat resistant neck 20 is provided with a continuous thread ridge 22, which is disposed around the outer circumference of the neck wall 21. A wide bead ring 24 is disposed under the thread ridge 22 and is connected thereto. A thick neck ring 25 is disposed below this bead ring 24. The thread ridge 22 has a short start 23 at the upper end of the ridge, and the minor diameter of the external thread is equal to the outer diameter of the mouth, r1.

Because the heat resistant neck 20 has the tall bead ring 24 and thick neck ring 25, it is possible for the neck 20 to withstand the strong forces applied when the aluminum Pilfer proof cap is fitted to the neck and when the cap is taken away. The neck 20 is prevented from inappropriate shrinkage deformation in the longitudinal direction when this portion is whitened by thermal crystallization, because the bead ring 24 is tall and is connected to the thread ridge 22. As described above, the outer diameter of the mouth, r1, is equal to the minor diameter of external thread, r3, in this heat resistant neck 20. Therefore, the change in the thickness of the neck wall 21 is fully small in the radial direction and is distributed quite uniformly in the circumferential direction. As a result, the shrinkage deformation in the radial direction caused by thermal crystallization occurs uniformly in the circumferential direction. Moreover, the thickness of the neck wall 21, i.e., the outer diameter of the mouth, r1, minus the bore diameter of the mouth, r2, is set at as small a value as possible, to minimize the amount of resins used, within the range capable of having the controlling effects on the inappropriate shrinkage deformation accompanied by the thermal crystallization.

Thus, when the PCO neck 10 is compared with the heat resistant neck 20, it is found that the synthetic resin consumed by the PCO neck 10 is in a small amount, as compared to the amount consumed by the heat resistant neck 20. Therefore, if the PCO neck 10 can be imparted with the heat resisting property by the thermal crystallization treatment, then a great deal of resources may be saved. Especially because plastic Pilfer proof cap is the current mainstream, it is possible for the heat resistant PCO neck 10 to find quite a wide range of applications.

However, when the PCO neck 10 is treated for thermal crystallization, a problem arises in which undesired shrinkage deformation occurs with the progress of thermal crystallization. As a result, capping operation gets out of order, and the sealing ability of the bottle decreases greatly.

Probably this problem has arisen because the change in wall thickness was too large for the average wall thickness of the PCO neck 10. The large change was caused by the facts that the PCO neck 10 is provided with the intermittent thread ridges, that the minor diameter of external thread, r3, was smaller than the outer diameter of the mouth, r1, of this neck, that the bead ring 14 and the neck ring 15 were not tall in their height, and that the bead ring 14 was placed separately from the intermittent thread ridges 12.

The conventional cap 30 is provided with a sealing lip 31 to give the sealing function to the lower, outside portion of the lining 32, and this sealing lip 31 is disposed at a lower position than in the pressure cap. As shown in FIG. 8, a problem arises when the cap 30 is fitted. The sealing lip 31 of the cap 30 bumps against the upper side of the extended start ridge 13, and may cause the fitting of the cap 30 to go out of order.

### SUMMARY OF THE INVENTION

This invention has been made to solve the above-described problem. The technical task of this invention is to obtain the PCO heat-resistant neck by utilizing the PCO neck structure. The object of this invention is to give the heat resisting property to the PCO neck and thereby to obtain a PCO heat-resistant neck that makes a great deal of resources saving a reality.

In this invention made to solve the above-described technical problem, the means of carrying out the invention comprises:

a round neck, with its wall having the same outer and bore diameters as the corresponding neck wall of the conventional heat-resistant bottleneck, which is the thermally crystallized, heat-resistant bottleneck;

the thread ridge of a continuous thread structure disposed on the outer circumference of the round neck wall; with the extension at the start point of the thread ridge disposed so as to keep a fixed distance from the top edge of the mouth and extending over the distance that corresponds to as wide a central angle as possible; and

a bead ring disposed below the thread ridges and a neck ring disposed below the bead ring, with both the bead ring and neck ring being molded in the same shapes as the bead ring and the neck ring of the PCO bottleneck, which is for exclusive use with a plastic Pilfer proof cap;

wherein the entire bottleneck is thermally crystallized and whitened.

When the round wall is thermally crystallized and shrunken in the radial direction, this shrinkage deformation is not out of order, but is uniform and reasonable because the outer and bore diameters of the round neck of this invention are equal to those of the conventional heat-resistant neck, and because the thread ridge of the round neck of this invention is also identical with that of the conventional heat-resistant neck.

The bead ring and the neck ring are identical with those of the PCO neck, which has fallen into irregular deformation. In this invention, however, irregular shrinkage deformation, such as a shrink mark or marks on the top edge of the neck wall, is prevented from occurring, due to the countermeasures that include the thread ridge of a continuous structure and the provision of an extension to the thread ridge.

The provision of the extension to the thread ridge makes it possible to minimize the differences in the distance from the top edge of the neck to various portions of the thread ridge including the extension. This extension in turn serves to lessen the difference in the extent of thermal shrinkage deformation in the longitudinal direction, which occurs in those portions, and to prevent the neck from irregular shrinkage deformation that appears as a shrink mark or marks on the top edge of the neck wall.

Thus, the neck of this invention has a larger volume of resin consumption than the PCO neck because of such conditions as the thread ridge of the continuous thread structure, the minor diameter of external thread, which is equal to the outer diameter of the mouth, and the same outer and bore diameters of the mouth as those of the heat-resistant neck. However, the neck of this invention has a smaller volume of resin consumption than the heat-resistant neck because the bead ring and the neck ring are provided in the same way as in the PCO neck, but are much smaller in their sizes than the corresponding ones on the PCO neck.

The invention of claim 2 includes the invention of claim 1 and also comprises that the upper side of the thread extension has almost the same flank angle as on the upper side of the thread ridge.

In the invention of claim 2, the upper side of the thread extension has almost the same flank angle as on the upper side of the thread ridge, as described above. In other words, the upper side of the thread extension has an outward downslope. Therefore, even if the sealing lip of the heat-resistant cap is located at a position slightly lower than the sealing lip of the pressure cap, the upper side of the thread extension is allowed to escape downward from the sealing lip of the cap that comes down from above when it is fitted. Thus, the sealing lip of the cap never bumps against the upper side of the thread extension, and the cap can be fitted onto the bottleneck suitably.

### BRIEF DESCRIPTION OF THE DRAWINGS

FIG. 1 is a front view of the entire bottle in the preferred embodiment of this invention.

FIG. 2 is an enlarged view of the neck in the preferred embodiment of this invention shown in FIG. 1.

FIG. 3 is a partial longitudinal section of the neck in the preferred embodiment of this invention shown in FIG. 2.

FIG. 4 is an expanded explanatory diagram showing the thread ridge in the preferred embodiment of this invention shown in FIG. 2.

FIG. 5 is a partial, enlarged, longitudinal section showing the cap fitting in the preferred embodiment of this invention shown in FIG. 2.

FIG. 6 is a front view of a conventional PCO neck structure.

FIG. 7 is a partial longitudinal section of the conventional neck shown in FIG. 6.

FIG. 8 is a partially enlarged, longitudinal section showing the conventional neck shown in FIG. 6, to which the cap has been fitted.

FIG. 9 is a front view of a conventional, heat-resistant neck.

FIG. 10 is a partial longitudinal section of the conventional neck shown in FIG. 9.

### PREFERRED EMBODIMENT OF THE INVENTION

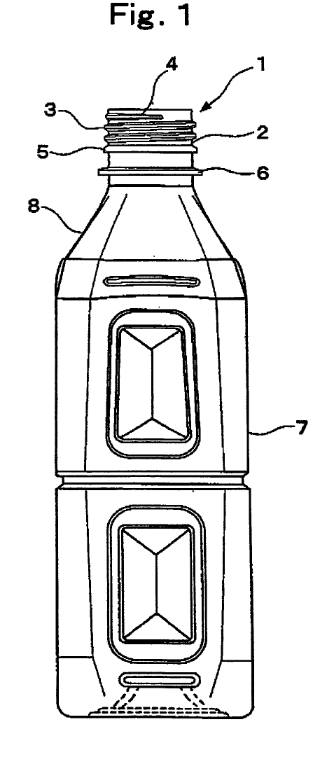

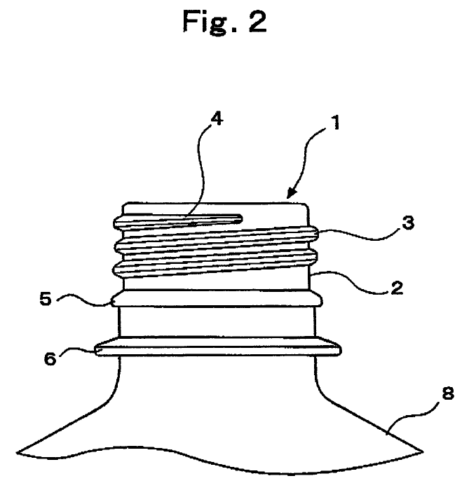

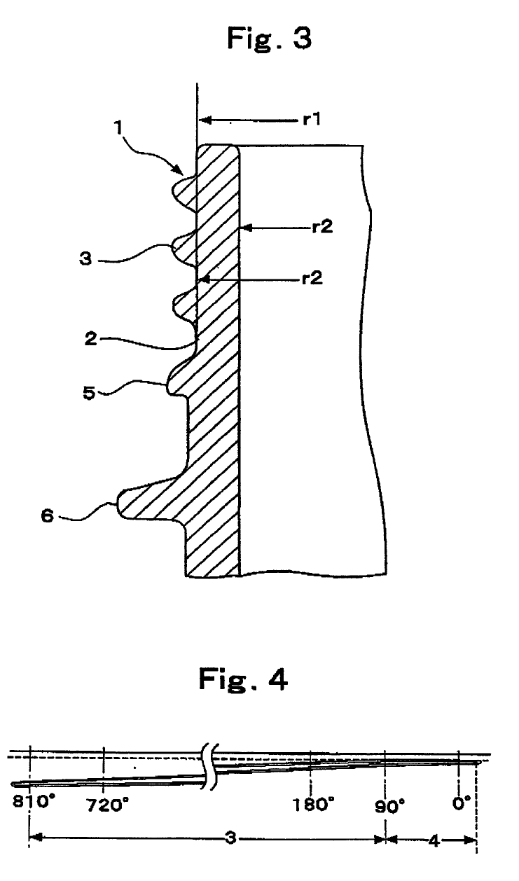

This invention is further described for an embodiment, now referring to FIGS. 1-5.

FIG. 1 is a front view showing the entire bottle in an embodiment of this invention. The bottle is a biaxially stretched and blow molded bottle of a polyethylene terephthalate resin. In its structure, the bottle comprises the bottomed square body 7, the shoulder 8 with a shape of truncated pyramid, disposed on the square body, and the round neck 1 of this invention disposed in the top portion of the bottle.

The neck 1 is provided with the continuous thread ridge 3 with a length of about 2 coils, and the ridge 3 is disposed circumferentially on the upper half of the neck 2. The bead ring 5 and the neck ring 6 are disposed circumferentially on the lower half of the neck 2, and have the structures similar to the corresponding bead ring 14 and neck ring 15 on the prior-art PCO neck 10 shown in FIG. 6.

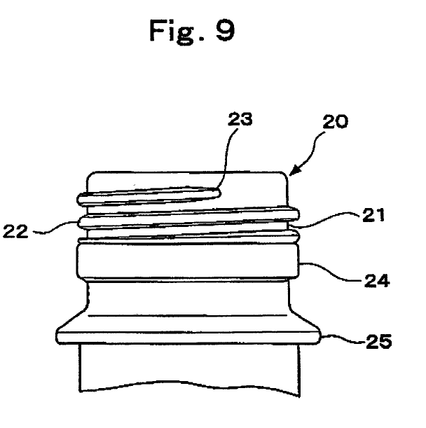

The thread ridge 3 has the same continuous spiral structure as used for the thread ridge 22 in the prior-art heat-resistant neck 20 shown in FIG. 9. The thread ridge 3 retains also the same relationship among the outer diameter of the mouth, r1, the bore diameter of the mouth, r2, and the minor diameter of external thread, r3, as found in the prior-art heat-resistant neck 20. However, the dimensions (ridge height and ridge width) of the thread ridge 3 are set at lower levels than the thread ridge 22 of the heat-resistant neck 20, just as these dimensions are set at lower levels for the PCO neck 10. This is because only plastic Pilfer proof cap is fitted to the neck of this invention, and the thread ridge of such a smaller size helps save the resources.

The thread ridge 3 is provided with the extension or the start ridge 4 disposed at the upper end of the thread ridge 3 over the distance that corresponds to as large a central angle as possible (about 90 degrees in the embodiment illustrated in FIG. 4). The underside of this extension extends just like that of the thread ridge 3. On the other hand, the upper side of the extension 4 has a lead angle of 0 degree and keeps a certain predetermined distance from the top edge of the neck wall 2, although the extension has almost the same flank angle, f, as that of the thread ridge 3.

Thus, in its structure, the extension 4 of the thread ridge 3 makes the width decrease gradually, without reducing the ridge height as the ridge comes close to its end.

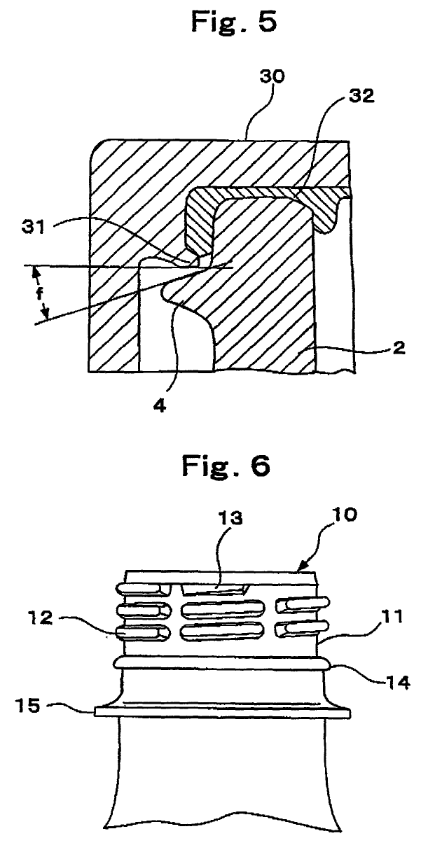

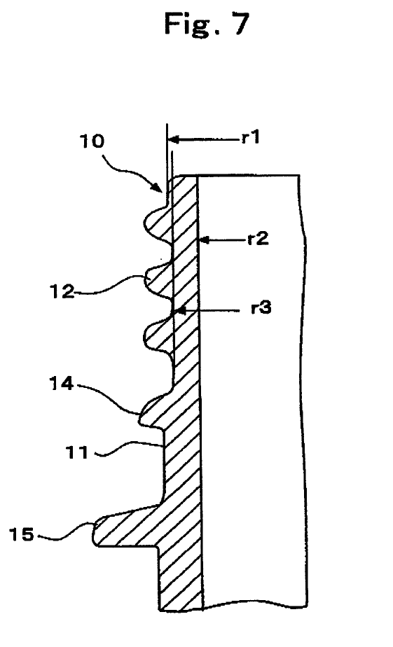

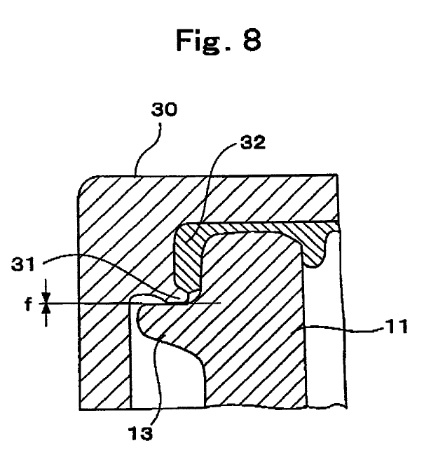

The upper side of the extension 4 has an outward downslope at a certain flank angle, f. As shown in FIG. 5, the thread ridge 3 makes an escape downward from the sealing lip 31 of the cap 30 at the time when the bottle is fitted with the heat-resistant cap 30 having a sealing ability toward the lower outside of the lining 32. In this arrangement shown in FIG. 5, there is no fear that the cap 30 would get out of order if the sealing lip 31 were to bump against the upper side of the thread ridge extension 4.

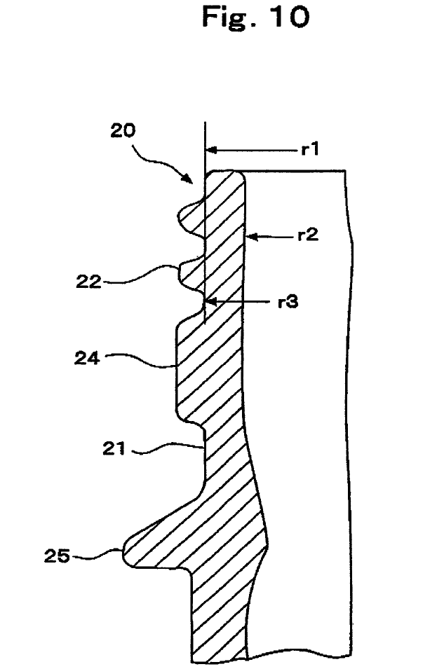

At present, the heat-resistant neck 20 of a 28-mm diameter shown in FIGS. 9 and 10 is the mainstream of the bottleneck of the heat-resistant type (including the heat- and pressure-resistant type), which is obtained by thermal crystallization of a polyethylene terephthalate (PET) resin bottle for the beverage use. This heat-resistant neck weighed about 7.6 g. When the neck 1 of this invention, shown in FIG. 1 or FIG. 5, was used instead of the heat-resistant neck 20, the neck could be lighter by 1 g, and yet there could be obtained equivalent levels of performance, including the heat resistance, the sealing ability, and the mechanical strength.

According to the invention of claim 1, the neck of the PCO-compatible type can be suitably treated for thermal crystallization without causing any irregular deformation. It is thus possible to make the PCO neck heat-resistant easily and securely so as to obtain the heat-resistant neck of a synthetic resin bottle of this invention. The configuration utilizing the PCO neck structure assures the reduction in the amount of resin used for the neck and allows an effective saving of resources.

According to the invention of claim 2, it is possible to fit the prior-art plastic Pilfer proof cap onto the neck of this invention safely and smoothly. The fitting operation can be quick and less expensive. The bottleneck of this invention is thus suitable as the heat- and pressure-resistant neck for exclusive use jointly with the plastic Pilfer cap.

What is claimed is:

1. A heat-resistant neck of a synthetic resin bottle, said bottleneck comprising a round neck wall (2) having the same outer and bore diameters as, the corresponding neck wall (21) of the heat-resistant bottleneck (20), which is a conventional, thermally crystallized, heat-resistant bottleneck; the thread ridge (3) of a continuous thread structure disposed on the outer circumference of the round neck wall (2); the extension at the start point of the thread ridge disposed so as to keep a fixed distance from the top edge of the mouth and extending over the distance that corresponds to as wide a central angle as possible; and a bead ring (5) disposed below the thread ridge and a neck ring (6) disposed below the bead ring (5), said bead ring (5) and neck ring (6) being molded in the same shapes as the bead ring (14) and the neck ring (15) of the conventional PCO bottleneck (10), which is exclusively used with a plastic Pilfer proof cap; wherein the entire bottleneck is thermally crystallized and whitened.

2. The heat-resistant neck of a synthetic resin bottle, according to claim 1, wherein the upper side of the thread extension (4) has almost the same flank angle (f) as on the upper side of the thread ridge (3).
